(19) United States
(12) Patent Application Publication
(10) Pub. No.: US 2010/0203485 A1
(43) Pub. Date: Aug. 12, 2010

(54) Method for teaching multiplication and factorization

(76) Inventor: Christopher Hansen, Lansing, MI (US)

Correspondence Address: Mikhail Murshak;BUTZEL LONG, Suite 1100, 110 West Michigan, Lansing, MI, 48933, US

(21) Appl. No.: 12/658,233

(22) Filed: Feb. 4, 2010

Related U.S. Application Data
(60) Provisional application No. 61/206,834, filed on Feb. 6, 2009.

(51) Int. Cl. G09B 1/00; G09B 29/00

(52) U.S. Cl. 434/207; 434/209; 434/430

(57) ABSTRACT

A method includes the steps of providing at least one whole number displayed in a discrete area and at least one factor from 1 to 10 for each at least one whole number. Each at least one factor is displayed in the discrete area occupied by the at least one whole number. Each factor from 1 to 10 is positioned in a unique horizontal and a unique vertical position relative to the other factors from 1 to 10 in the discrete area of the at least one whole number. Each factor from 1 to 10 is assigned with a unique indicia distinguishing that factor from each other factor from 1 to 10 that is not the same factor. The method can be used to teach skip counting, multiplication, division, multiples, fractions, factorization, and the like.

### CROSS-REFERENCE TO RELATED APPLICATIONS

This application claims the priority benefit of U.S. Provisional Application No. 61/206,834 filed Feb. 6, 2009, which is incorporated herein by reference in its entirety.

### BACKGROUND

The present disclosure relates generally to systems and methods for math education in learning multiplication and factorization, and in particular math education for students in grades K-12.

### DESCRIPTION OF THE RELATED ART

Educational devices for teaching mathematics are known. Prior educational devices employed rather complex means for teaching addition, subtraction, multiplication, or division. In one example, overlays having various openings therein were located above number boards, and such overlays were manipulated to obtain the desired results. In another example, a frame having slidable rods was combined with light emitting means to teach the multiplication tables. For the most part, such educational devices were expensive and taught only one mathematical operation.

Previous educational devices were primarily for educational purposes and were operated by only one person at a time. Such devices usually did not provide entertainment, nor did they provide competition between various persons. Thus, for the most part, children quickly became bored with such devices. Moreover, learning to use the devices was burdensome and complicated. Particularly, learning multiplication and factorization are often difficult for children to understand without employing challenging memorization techniques. Factoring, for example, does not follow a distinct and easy to understand pattern for all numbers, especially when trying to learn prime numbers.

Accordingly, it is an object of the present invention to provide an educational device employing a more visibly identifiable and easy to learn system and method for understanding multiplication and factorization. It is a further object of the present invention to provide easily identifiable charts and images that allow an individual to quickly identify relationships between numbers including prime numbers. It is a still further object of the present invention to provide a game for teaching attributes of various numbers. It is still yet another object of the present invention to provide an educational device that is inexpensively constructed. It is yet another object of the present invention to provide a system that can hold the interest of children over an extended period of time while they are learning mathematics.

### SUMMARY

The present disclosure provides for a method comprising the steps of: (a) providing at least one whole number displayed in a discrete area; (b) providing at least one factor from 1 to 10 for each at least one whole number, each at least one factor being displayed in the discrete area occupied by the at least one whole number; and (c) positioning each factor from 1 to 10 in a unique horizontal and a unique vertical position relative to the other factors from 1 to 10 in the discrete area of the at least one whole number; and (d) assigning each factor from 1 to 10 with a unique indicia distinguishing that factor from each other factor from 1 to 10 that is not the same factor. In an example, the indicia can be unique color designated to each of the factors 1 to 10. The color indicia can be provided as a stripe within the discrete area occupied by the at least one whole number.

In a further example, the method further includes providing a plurality of whole numbers, each whole number in visibly separated discrete areas arranged in a chart, wherein each discrete area displays at least one factor from 1 to 10, a prime indicator associated with a prime number, or a combination thereof. The prime indicator can be the word “prime.” The discrete area can be a box displaying the at least one whole number and the at least one factor from 1 to 10, a prime indicator associated with a prime number, or a combination thereof. In an even further example the plurality of whole numbers are positioned in 100 visibly separated discrete areas displayed in at least a first chart of ten rows and ten columns defining an array of whole numbers increasing chronologically from 1 to 100. The method can further include the step of providing a second chart defining 100 discrete areas in ten rows and ten columns having whole numbers 101 to 200 in the discrete areas increasing consecutively along the ten rows and ten columns. Prime factors can be provided in the discrete areas of whole numbers between 101 and 200 that are the product of only prime numbers not between 2 and 10. In yet an even further example, the first chart and the second chart are displayed on opposite sides of an integral printed object. A key can be provided of factors 1 to 10 displaying the unique indicia for each of the factors 1 to 10.

In an example, the at least one number is provided on a printed object selected from the group consisting of a flash card, a sheet of paper, a poster, and combinations thereof. In a further example, the at least one number is displayed electronically. In an even further example, the method can further include the steps of teaching at least one mathematical concept selected from the group consisting of skip counting, multiplication, division, multiples, fractions, factorization, and combinations thereof.

The present disclosure provides for a method including the steps of: (a) providing a first display comprising a plurality of rows and columns forming discrete areas with a sequence of whole numbers beginning with 1 displayed above a first row horizontally and a sequence of whole numbers beginning with 1 displayed vertically adjacent a first column of the table as multipliers; (b) assigning a unique indicia to each unique multiplier distinguishing that multiplier from the other multipliers on the display that are not the same multiplier; (c) displaying a product of the multipliers in the discrete areas formed by an intersection of each of the multipliers; and (d) displaying each of the multipliers in the respective discrete areas occupied by the product thereof, including the indicia associated with each such multiplier. The indicia can be color. In an example, a colored stripe of the multipliers can be provided within the discrete area. In a further example, the plurality of rows and columns include 10 rows and columns having whole numbers 1 to 10 displayed above the first row and adjacent the first column forming a chart of 100 discrete areas of products by the intersection of each row and column. In yet a further example, the method further includes the steps of: (i) providing a display of a plurality of charts, each chart displaying whole numbers of 1 to 100 in discrete areas; (ii) associating each chart with one unique whole number of the plurality of whole numbers, and (ii) providing indicia of each multiple from 1 to 100 in each chart of the assigned whole number. The method can further comprise the steps of displaying the first display on a first side of a printed object and displaying the plurality of charts on an opposite side of the printed object.

The present disclosure provides methods having one or more steps that can be performed simultaneously, in any order, or consecutively.

### BRIEF DESCRIPTION OF THE DRAWINGS

The application contains at least one drawing executed in color. Copies of this patent application publication with color drawings will be provided by the office upon request and payment of the necessary fee.

FIG. 1 illustrates an example chart of factorization from 1 to 100.

FIG. 2 illustrates an example of factorization from 101 to 200.

FIG. 3 illustrates a color coded key of factors 1 to 10.

FIG. 4A illustrates an example row from 11 to 20 of the chart from FIG. 1.

FIG. 4B illustrates an example row from 141 to 150 of the chart from FIG. 2.

FIG. 5 illustrates a multiplication chart with color indicia.

FIG. 6 illustrates multiple charts of 1 to 100 with color indicia for multiples of each designated chart.

FIG. 7 illustrates an example row of the multiple “2” from the chart of FIG. 5.

FIG. 8 illustrates an example chart of “multiples of 2” from FIG. 6.

### DESCRIPTION

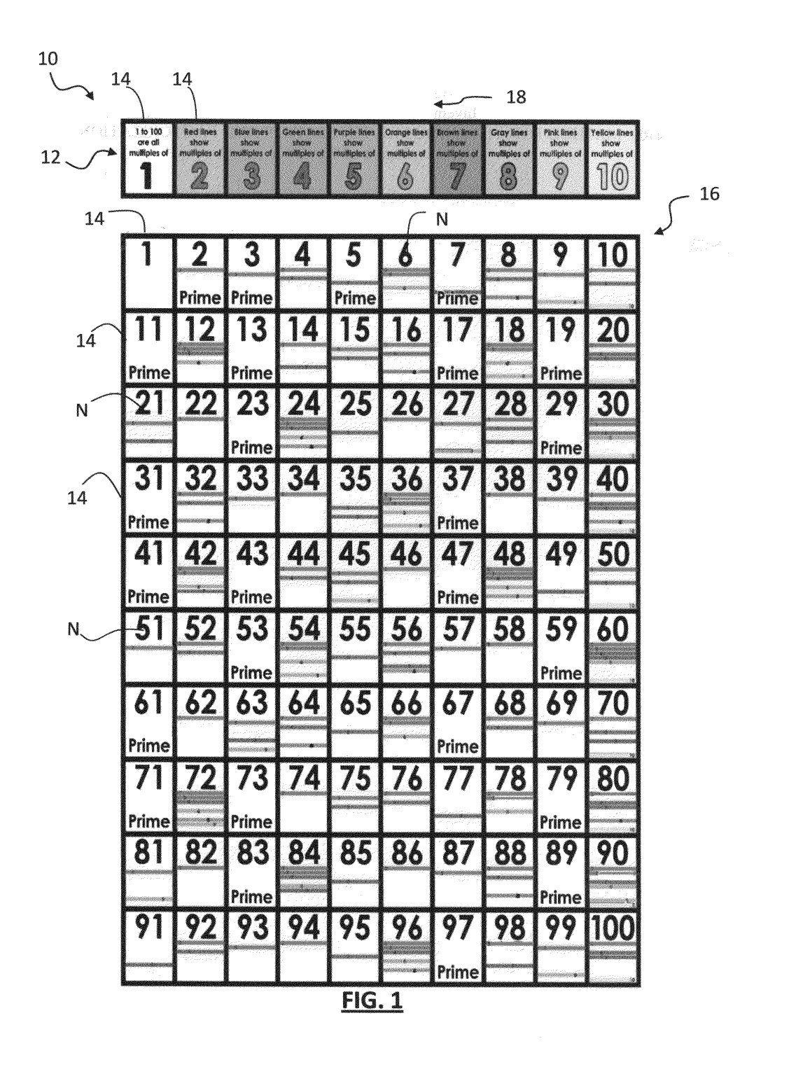

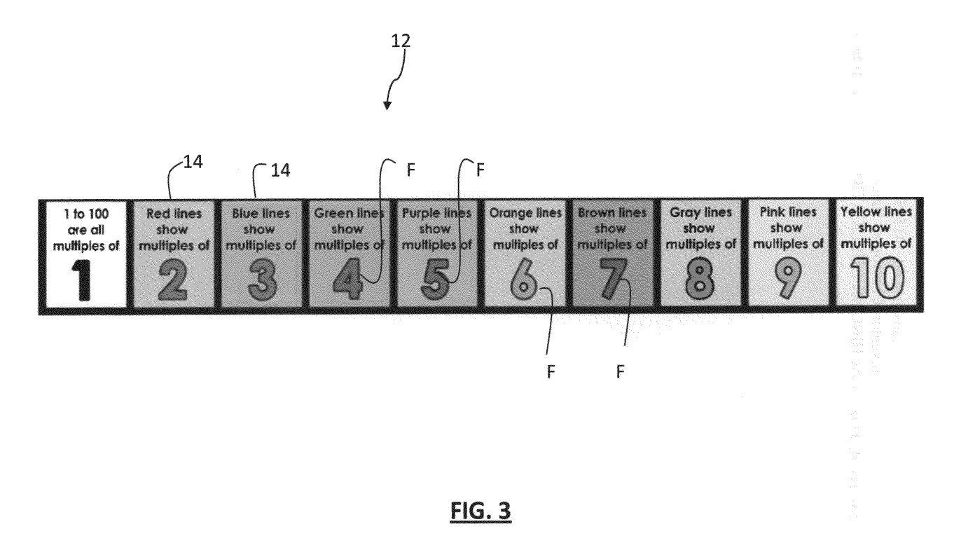

Systems and methods for teaching mathematical concepts are provided. Referring to FIGS. 1-4B, an example factorization display 10 is provided. Display 10 functions as a teaching aid. Display 10 can include a key 12 listing whole number factors F from 1 to 10 consecutively in a row. Each factor F is positioned in a discrete area 14. In this example, each discrete area is a box 14. Each factor F is designated with a unique indicia that distinguishes that factor from the other factors. In this example, the indicia are colors. Key 12 can be color coded as shown in FIGS. 1 and 3. The colors can be mixed and matched such that no two unique factors from 1 to 10 share the same indicia. In this example, each number 1 to 10 in key 12 is assigned its own color coding. The number 1 is shown in black with white background. The number 1 is in the key with a statement that all numbers from 1 to 100 are multiples of 1. According to the example of FIG. 1, the number 2 is red, the number 3 is blue, the number 4 is green, the number 5 is purple, the number 6 is orange, the number 7 is brown, the number 8 is grey, the number 9 is pink, and the number 10 is yellow. Other example indicia such as patterns, shapes, combinations of colors or patterns, and the like are within the scope of the present disclosure. In a further example, sound or texture can be used as indicia. This is particularly useful for teaching aids for the visually impaired.

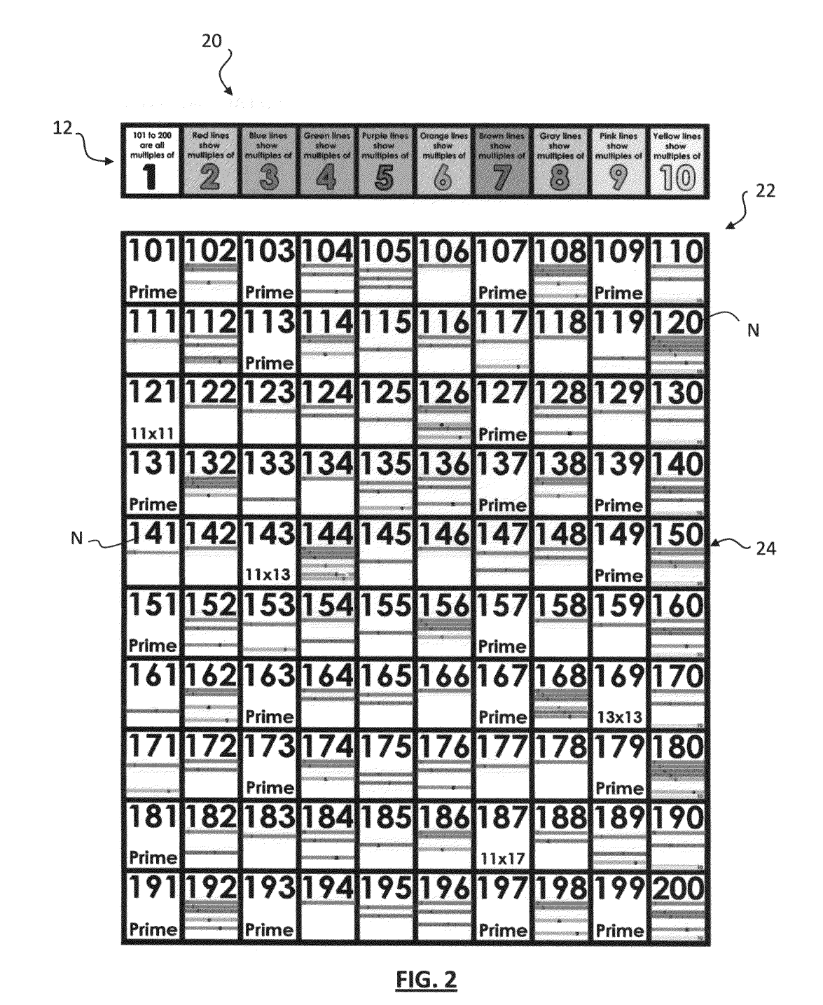

In an example at least one number is provided in a discrete area 14. In a further example, a plurality of discrete areas 14 are provided each having a different whole number. As shown in FIG. 1, the plurality of discrete areas 14 form a chart 16 of one hundred squares 14. Each square includes a whole number. The numbers start at “1” and increase consecutively to “100” from left to right and top to bottom. Key 12 can be displayed above the chart 16 to provide visual convenience. In another embodiment, key 12 is provided as a separate object or display unattached from the chart 16. A label 18 can be provided which reads, for example, “1 to 100” as a further visual indicator. In a further example, a display 20, as shown in FIG. 2, includes a chart 22 of numbers “101 to 200” and a key 12 directly above chart 22.

Each example discrete area 14 includes a whole number “N” from 1 to n. The variable n can be any number greater than 1. In chart 16, n can be any number from 2 to 100 and in chart 22, n can be any number from 101 and 200. In this example, N is shown in Black to distinguish from the color coding of the factors. At least one factor F of that whole number N is provided in the box 14 occupied by that whole number N. Factor F is between 1 and 10 and is assigned with designated indicia. In the examples of FIGS. 1-4B, the indicia are unique color designated to each factor F as shown in the key 12. Referring to whole number “12” of chart 16, the whole number 12 is displayed in a box 14 and has factors F of 1, 2, 3, 4, and 6. According to this example, those factors are shown in the box 14 of N equals 12. A colored stripe associated with each factor F of the number 12 extends across box 14 with the corresponding factor F displayed within the stripe. Accordingly, for example, an individual can quickly see the whole numbers N in chart 16 and associate every number N having a red stripe in the box 14 it occupies as having the number 2 as a factor. The factor F can also be displayed in a unique horizontal position relative to the other factors F from 1 to 10. Further, factor F can be displayed in a unique vertical position relative to the other factors F. Accordingly, each number N is shown with its factors easily recognizable by a unique color and relative horizontal and vertical position. This makes for convenient identification of patterns and factors associated with various numbers.

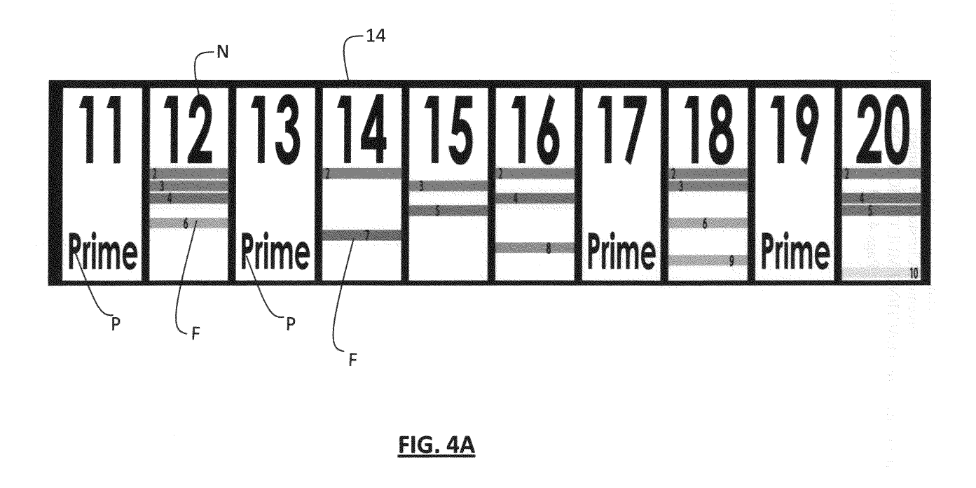

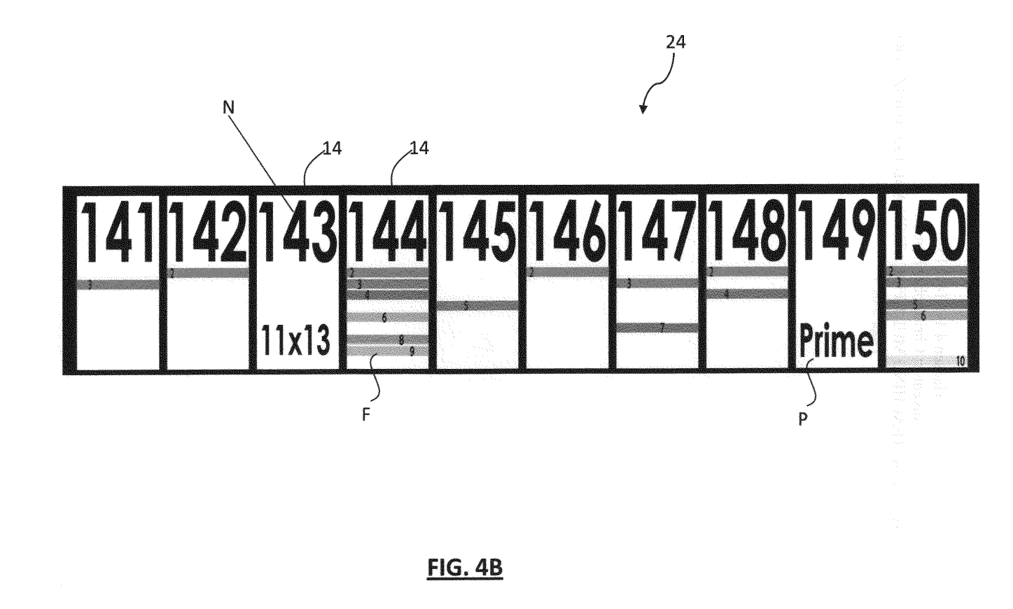

Prime numbers N such as 2, 3, 5, and 13 include a further Prime identifier “P” in their respective discrete area 14. In this example, the identifier “P” is the word “prime” as shown throughout charts 16 and 22. Chart 22 includes numbers that do not have any factors F from 2 to 10 but instead have the number “11” or “13” as a factor along with another multiplier. This is because whole numbers exist in the range from 101 to 200 that are products of prime numbers that are greater than 10 (i.e., “11” and “13”). FIG. 4B shows an example row of whole numbers from 141 to 150 with the whole number 143 being a product of prime numbers 11 and 13. Numbers “121, 143, 169, and 187” do not have a factor F from 2 to 10 but instead are products of some combination of prime numbers 11 and 13. Accordingly, their respective discrete areas 14 include an expression of the multipliers which are prime needed to produce that number. In the box 14 that has number 121, the expression 11×11 is shown. Similarly for the number 143 (shown in FIG. 4B), the expression 11×13 is shown, for the number 169, the expression 13×13 is shown, and for the number 187, the expression 11×17 is shown.

In an example, display 10 and 20 can be provided on opposite sides of an integral printed object as a teaching aid. A printed object can be paper, plastic, laminated material, or the like provided as teaching aids. In a further example, the charts are provided on 8.5×11 inch sheets and handed to students in a classroom. The chart from 1 to 100 can be on first side with the chart from 101 to 200 on a second side. In another example, the displays 10 and 20 are provided on posters, for example defining dimensions of 36 inches by 24 inches to hang in a classroom or the like. In an even further example, the displays are provided electronically to be viewed on a computer monitor or the like. The displays can be provided through software or on a CD-Rom. In an even further example, each unique discrete area is provided on a separate flash card or game card having a first and second side. The first side can have the number N with factor(s) F and the second side can include a design to obstruct view. Flash cards and games are further examples how factorization can be taught using the system and method of the present disclosure. The systems and methods for teaching factorization of the present disclosure help individuals learn and understand addition, subtraction, skip counting, multiples, multiplication, factors, factorization, division, prime numbers, common factors, common multiples, among others. In an even further example, a kit can be provided that comprises two or more of the teaching aids described herein above. An example kit includes two posters, one for each display 10 and display 20, and a plurality of double sided handouts provided to each student in a class. The teaching aids can be provided in any media described herein or combination of media.

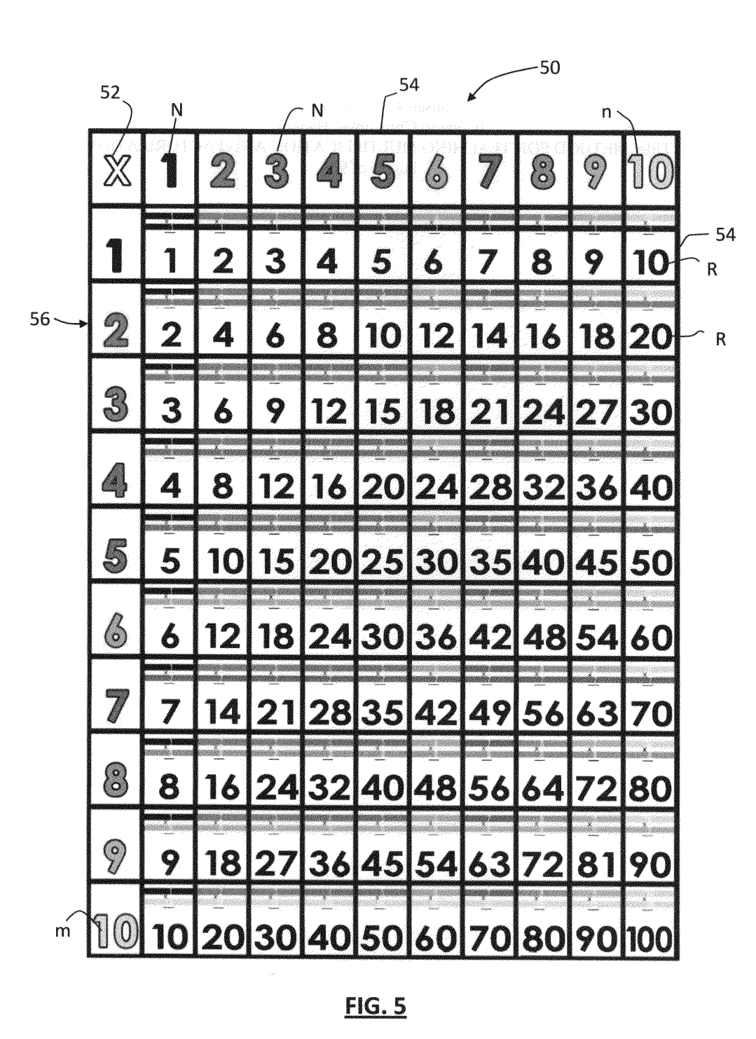

Referring to FIGS. 5-8, in an example, the present disclosure provides for method and systems for teaching mathematical concepts such as multiplication. FIG. 5 shows an example of a multiplication chart 50. The function of multiplying can be represented in the upper left hand corner of chart 50 with an example identifier 52 such as the letter “X,” a common symbol in mathematics for multiplying. Numbers N from 1 to n can be provided along both columns and rows forming chart 50. In a further example, numbers N from 1 to n are provided horizontally and numbers N from 1 to m are provided vertically. The variables “n” and “m” can be equal as shown in FIG. 5 where n and m are both equal to 10 forming a 10 by 10 chart of products formed by the multipliers in each row and column. However, n and m can be different numbers greater than or equal to 1. For example, n can be 10 and m can be 5 forming a chart of 50 products of the multipliers. In the example of chart 50, n and m are equal. Each number N occupies a discrete area 54. In this example, the numbers N are displayed from 1 to 10 in each row and column. In the example of chart 50, each discrete area 54 forms a box with the number N shown in the box.

The intersection of each row and column forms a product R of the two multipliers provided adjacent the first column and above the first row of products. Product R is displayed in each discrete area 54 of chart 50. Each multiplier 1 to n or m can be assigned unique indicia distinguishing that multiplier from the others n or m that are not the same multiplier. Typically, each indicia are assigned to which ever number n or m is greater. For example, if n equals 8 and m equals 9, then 9 indicia will be provided. The first 8 indicia will be the same for both n and m. As shown in chart 50, the indicia are color and each number N from 1 to 10 is shown in each discrete area 54 having a different color. The color coding can be identical to that of key 12 from FIGS. 1, 2, and 3.

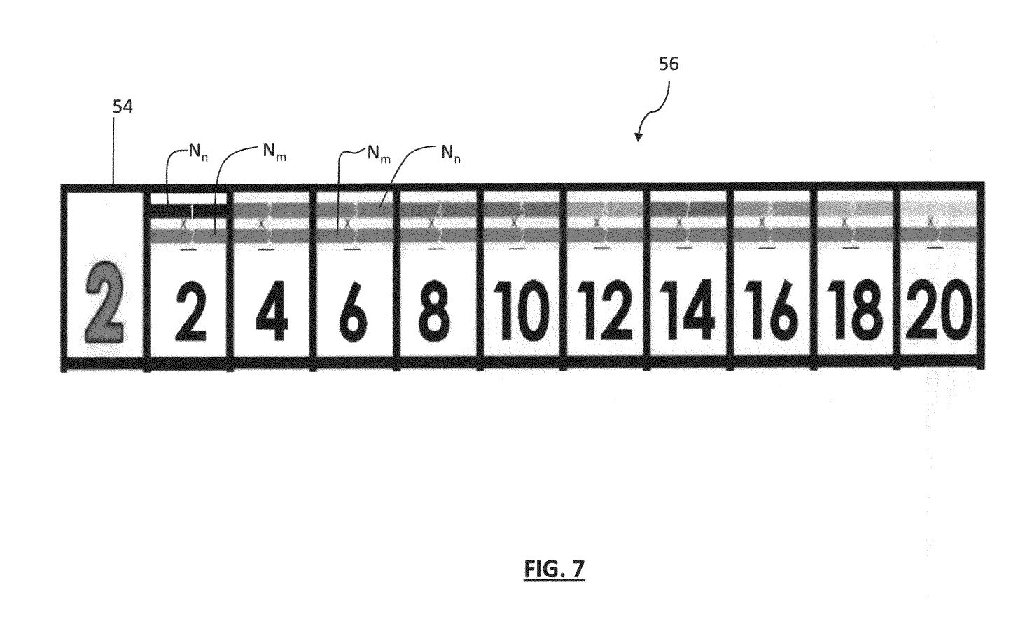

FIG. 7 shows an example row 56 of N equals 2. The number “2” is shown in red (i.e., the indicia for the number 2). In each discrete area 54 from chart 50 in the row of N equals 2 a product R is provided formed by multiplying the number 2 with the N from the respective column. The product R is displayed in black in this example. Also provided in each discrete area 54 of the product R are the respective multipliers from each row and column. The number N from the columns is shown as Nₙ and the number from the rows is represented as Nₘ. The color indicia associated with each number N is provided with the multiplier. The indicia can be represented as a color stripe extending across the box 54 with the number Nₙ or Nₘ disposed within the stripe. For example, for product R equals 6, the multipliers are “2” and “3” shown above the number 6 in the discrete area 14 occupied by the number 6. A multiplication symbol “X” is provided between the multipliers “2” and “3” for further teaching aid. Accordingly, a user of the system can visually see from the color indicia, a relationship between the number “2” and the products in the row. Similarly, multiplication relationships can be seen vertically as well.

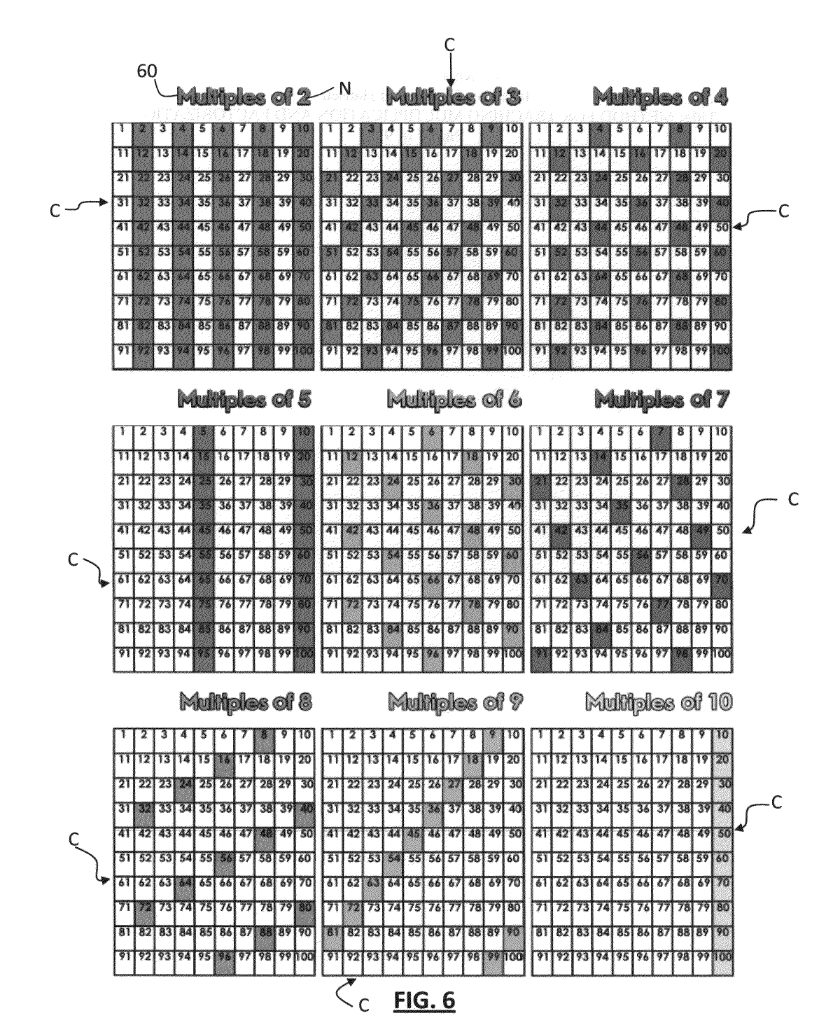

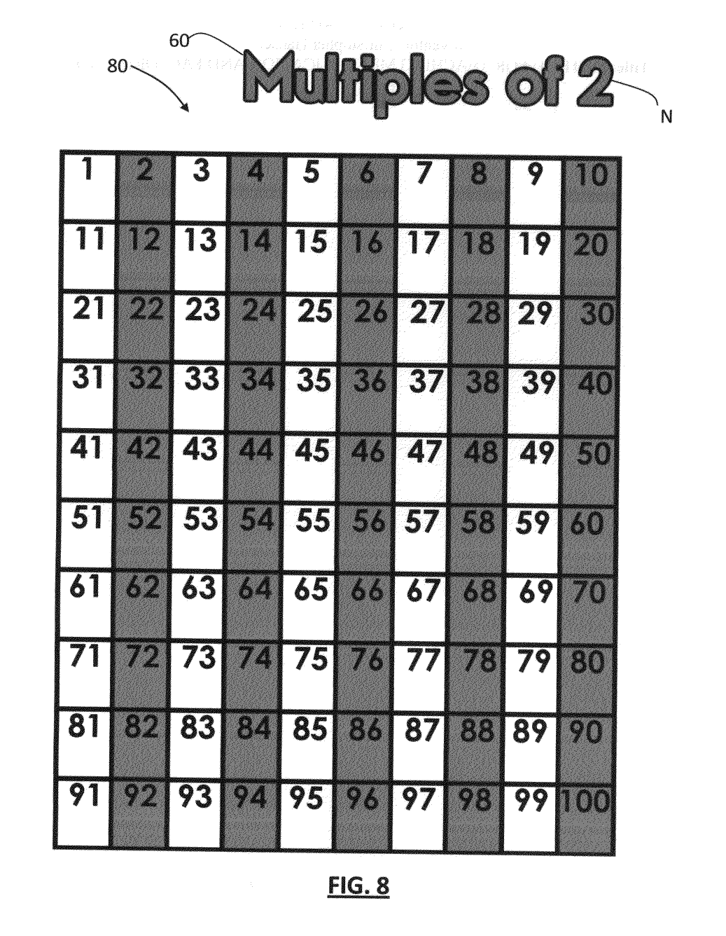

The present disclosure further provides for displaying several charts “C,” each having numbers 1 to 100 in a 10 by 10 array. In this example, each chart C is identified by a title 60 in the color of that number N. The title can be any distinguishing expression. As shown in FIGS. 6 and 8, the title states, ‘Multiples of N,” wherein N is the multiple associated with each chart. For example, chart 80 (FIG. 8) states “Multiples of 2” and is displayed in red as the indicia associated with N equals 2. In each chart C, the multiples of that number N from 1 to 100 are shown in the designated indicia of that multiple N. Accordingly, chart 80 is for N equals 2 and each discrete area occupied by a number from 1 to 100 that is a multiple of 2 is colored red (the indicia of N equals 2). In FIG. 6, nine charts are shown with each chart having a unique color pattern associated with its number N. A user of the charts C can quickly see which numbers include the associated number N as a multiple. In a further example, chart 50 and charts C are provided on opposites sides of a printed object. In an even further example, the chart 50 is displayed on a poster and charts C are displayed on a poster.

In an example, the teaching aids of described above are provided in a kit of two or more of any of the displays and teaching aids. The kit can comprise any combination of the multiplication charts with the factorization charts in any combination of media including but not limited to posters, handouts, CD-Roms, software, flash cards and the like. In a further example, posters of each of display 10, display 20, chart 50, and charts C, are provided to a classroom or the like. Each student can further be provided with a double-sided sheet or handout with the same displays and charts. In a further example, each student is provided with two sheets. The first sheet displays display 10 on one side and display 20 on the other. The second sheet displays chart 50 and charts C on opposite sides. In an even further example, each number from displays 10 and 20 are provided on individual flashcards. The flashcards can be used as study tools or incorporated into a game. An example of a game using the flashcards would be to hand each player a designated number of cards from the deck. Then as cards are flipped over from the deck each player must match the card flipped over by multiple (i.e., color or position). Rules of the game can be adjusted to increase or decrease degree of difficulty.

Several examples of how the systems of the present disclosure can be used in a classroom include but are not limited to:

(1) Students can use the “1 to 100” and “101 to 200” displays to count from 1 to 200 on one printed object. Students count from 1 to 100 on one side and 101 to 200 on another side of the same object such as a printed piece of paper.

(2) Students can use the charts C to see all the multiples of 2 to 10 on individual 1 to 100 charts at the same time.

(3) Students can use the “1 to 100” and “101 to 200” images to skip count by 2, 3, 4, 5, 6, 7, 8, 9, or 10. Students look for the appropriate color line for the number they want to skip count by in the 1 to 100 or 101 to 200 images or the charts C and skip count accordingly. For example, a student can count by 7's by looking for all of the numbers with brown lines on the 1 to 100 or 101 to 200 chart (7, 14, 21, 28, 35, 42, etc.) or can look at the charts C to see all of the multiples of 7 from 1 to 100 at the same time.

(4) Students can identify multiples of 1 to 10 in 1 to 100 by using the color coding system by choosing a color/number and looking at the displays to find the color line under the numbers of multiples of the number they were looking for.

(5) Students can identify factors and common factors in 1 to 200. For example, the color lines show 72 has factors of 2, 3, 4, 6, 8, 9 and 66 has factors of 2, 3, and 6. The common factors of 72 and 66 are therefore 2, 3, and 6.

(6) Students can identify all 46 prime numbers from 1 to 200 by looking for numbers with the word “Prime” written underneath it in the box. For example, 43, 59, and 83 are prime numbers.

(7) Students can identify patterns in numbers by using the 1 to 100 chart and the 101 to 200 chart. For example students can see that 12, 24, 36, 48, and 60 are all multiples of 2, 3, 4, and 6 by looking at the color lines that are under each number. Students can also see that 108, 117, 126, 135, 144, 153, 162, and 171 are all multiples of 3 and 9 by following the numbers and color lines in a right to left angled pattern.

(8) Students can use the charts to find the least common denominator in addition or subtraction problems involving mixed fractions. For example if the math problem in question is 12/24+ 8/40, the student can use the chart to see that 4 is the largest common factor of 12, 24, 8, and 40. The student can then divide all numbers by 4 and reduce the problem to 3/6+ 2/10 and then recognize that 3/6 is the same as 5/10 and finish the problem by adding 5/10+ 2/10= 7/10.

(9) Students can use chart 50 to use multiplication to find the product of any two numbers from 1 to 10. For example, the process is made easier by the color line with a 7 in it above the color line with a 9 in it with the product 63 clearly stated.

(10) Students can use chart 50 in a reverse way to understand division. For example, if students are give the question 36/4. Students can find 4 on the horizontal color line and follow it down to the number 36. The 9 on the top of the problem 4×9=36 shows that 9 is the answer to 36/4.

Many modifications and variations of the present disclosure are possible in light of the above teachings. Therefore, within the scope of the appended claim, the present disclosure may be practiced other than as specifically described.

What is claimed:

1. A method comprising the steps of:
a) providing at least one whole number displayed in a discrete area;
b) providing at least one factor from 1 to 10 for each at least one whole number, each at least one factor being displayed in the discrete area occupied by the at least one whole number; and
c) positioning each factor from 1 to 10 in a unique horizontal and a unique vertical position relative to the other factors from 1 to 10 in the discrete area of the at least one whole number; and
d) assigning each factor from 1 to 10 with a unique indicia distinguishing that factor from each other factor from 1 to 10 that is not the same factor.

2. The method of claim 1 wherein the indicia is a unique color designated to each of the factors 1 to 10.

3. The method of claim 2 wherein the color indicia is provided as a stripe within the discrete area occupied by the at least one whole number.

4. The method of claim 1 further comprising the step of providing a plurality of whole numbers, each whole number in visibly separated discrete areas arranged in a chart, wherein each discrete area displays at least one factor from 1 to 10, a prime indicator associated with a prime number, or a combination thereof.

5. The method of claim 4 wherein the prime indicator is the word “prime.”

6. The method of claim 4 wherein the discrete area is a box displaying the at least one whole number and the at least one factor from 1 to 10, a prime indicator associated with a prime number, or a combination thereof.

7. The method of claim 4 wherein the plurality of whole numbers are positioned in 100 visibly separated discrete areas displayed in at least a first chart of ten rows and ten columns defining an array of whole numbers increasing chronologically from 1 to 100.

8. The method of claim 7 further comprising the step of providing a second chart defining 100 discrete areas in ten rows and ten columns having whole numbers 101 to 200 in the discrete areas increasing consecutively along the ten rows and ten columns.

9. The method of claim 8 further comprising displaying prime factors of whole numbers between 101 and 200 that are the product of only prime numbers not between 2 and 10.

10. The method of claim 8 wherein the first chart and the second chart are displayed on opposite sides of an integral printed object.

11. The method of claim 1 further comprising the step of providing a key of factors 1 to 10 displaying the unique indicia for each of the factors 1 to 10.

12. The method of claim 1 wherein the at least one number is provided on a printed object selected from the group consisting of a flash card, a sheet of paper, a poster, and combinations thereof.

13. The method of claim 1 wherein the at least one number is displayed electronically.

14. The method of claim 1 further comprising the steps of teaching at least one mathematical concept selected from the group consisting of skip counting, multiplication, division, multiples, fractions, factorization, and combinations thereof.

15. A method comprising the steps of:
a) providing a first display comprising a plurality of rows and columns forming discrete areas with a sequence of whole numbers beginning with 1 displayed above a first row horizontally and a sequence of whole numbers beginning with 1 displayed vertically adjacent a first column of the table as multipliers;
b) assigning a unique indicia to each unique multiplier distinguishing that multiplier from the other multipliers on the display that are not the same multiplier;
c) displaying a product of the multipliers in the discrete areas formed by an intersection of each of the multipliers; and
d) displaying each of the multipliers in the respective discrete areas occupied by the product thereof, including the indicia associated with each such multiplier.

16. The method of claim 15 wherein the indicia is color.

17. The method of claim 16 wherein a colored stripe of the multipliers is provided within the discrete area.

18. The method of claim 15 wherein the plurality of rows and columns include 10 rows and columns having whole numbers 1 to 10 displayed above the first row and adjacent the first column forming a chart of 100 discrete areas of products by the intersection of each row and column.

19. The method of claim 15 further comprising the steps of: (i) providing a display of a plurality of charts, each chart displaying whole numbers of 1 to 100 in discrete areas;
(ii) associating each chart with one unique whole number of the plurality of whole numbers, and (ii) providing indicia of each multiple from 1 to 100 in each chart of the assigned whole number.

20. The method of claim 19 further comprising the steps of displaying the first display on a first side of a printed object and displaying the plurality of charts on an opposite side of the printed object.
